(19) United States
(12) Patent Application Publication
(10) Pub. No.: US 2009/0200314 A1
(43) Pub. Date: Aug. 13, 2009

(54) Cooking Vessel with Handle

(75) Inventor: Hans-Jürgen Beck, Littau (CH)

Correspondence Address: GUARANTEED PATENT SERVICES;SONYA C. HARRIS, 2101 CRYSTAL PLAZA ARCADE, #107, ARLINGTON, VA, 22202-4616, US

(73) Assignee: AMC INTERNATIONAL ALFA METALCRAFT CORPORATION AG, Rotkreuz (CH)

(21) Appl. No.: 12/091,235

(22) PCT Filed: Oct. 13, 2006
(86) PCT No.: PCT/CH06/00571

§ 371 Date: Oct. 29, 2008

(30) Foreign Application Priority Data
Oct. 27, 2005 (CH) 01726/05

(51) Int. Cl. A47J 27/00; B65D 25/28

(52) U.S. Cl. 220/573.1; 220/752

(57) ABSTRACT

A cooking vessel has a handle, in particular for a pot or a pan, wherein the grip region of said handle is composed of metal. In this case, the handle has at least one first substantially metal fixing section for being fixed to the cooking vessel, a transition section and a substantially metal grip section. The transition section has a reduced metal cross section compared to the adjacent sections, wherein said transition section respectively comprises either a metal section, which is integrally connected to the adjacent sections, and a ceramic piece, or comprises only a ceramic piece, and the ceramic pieces are connected to the adjacent adjoining metal sections in an interlocking manner. The result of this is a reduction in thermal conductivity in the grip region without reducing the stability of the handle.

### TECHNICAL FIELD

The invention relates to a cooking vessel with a handle, in particular a pot or a pan with a handle, the grip region of said handle being made of metal, the handle having at least a first substantially metallic fastening portion for fastening to the cooking vessel, a transition portion and a substantially metallic grip portion, the transition portion having in cross section a metal cross section which is reduced compared to the adjacent portions.

### PRIOR ART

The prior art discloses a number of cooking vessels of this type with grips, in which there is a zone of transition to the cooking vessel itself, which zone serves as a thermal brake. FR 2,730,399 discloses a grip of this type consisting of a one-piece, flat, horizontally arranged metallic element in which there are arranged, in a region close to the cooking vessel, holes which locally reduce the metallically heat-conductive cross section and thus cause the grip region which is more remote from the cooking vessel to heat up less intensively for the user.

U.S. Pat. No. 5,121,848 discloses a pan with a metallic handle consisting of a single punched element which is bent over at its center and thus forms two hollow half-shells for the grip region. In the region close to the cooking vessel, the two ends of the handle, which are connected to the cooking vessel, are perpendicular to the bottom plane of the vessel and thus form between them a conduit through which, for example, hot air rising up the pan can ascend.

DE 92 11 465 U1 discloses a cooking vessel in which slots, which allow the passage of warm air rising up the pot, are provided in the edge region adjoining the handle.

The devices according to the prior art are all intended to facilitate the passage of warm air and gases rising up the cooking vessel, so said warm air and gases do not excessively heat the handle.

Some of these are very simple designs which are awkward for the user to handle. In addition, the provision of the various conduits leads to a weakening of the subsequent grip region and thus, in particular in the case of filled relatively large pots or pans, to instabilities of the handle, especially when used for a relatively long period of time.

### SUMMARY OF THE INVENTION

Starting from this prior art, the invention is based on the object of disclosing a cooking vessel which has an improved handle and in which the abovementioned drawbacks of the prior art are avoided. The term “cooking vessel” includes without limitation pans, high-sided frying pans, casseroles, pots, etc.—ultimately all kitchen appliances which can be placed on a hotplate or heating surface in a kitchen, irrespective of whether the heat is generated by induction, heating coils or gas flames.

This object is achieved by a cooking vessel with an improved handle according to the features of Claim 1 in that the transition portion respectively consists either of a metal portion, which is integrally connected to the adjacent portions, and a thermal barrier or exclusively of a thermal barrier, the thermal barriers being connected to the adjacent adjoining metal portions in an interlocking or force-transmitting manner.

The thermal barrier thus allows reduced conduction of heat into the grip region without reducing the stability of the handle.

Further advantageous embodiments are characterized in the sub-claims.

### BRIEF SUMMARY OF THE DRAWINGS

The invention will now be described by way of example based on a few exemplary embodiments and with reference to the drawings, in which:

FIG. 1 is a perspective exploded view of a handle for a cooking vessel according to a first exemplary embodiment of the invention;

FIG. 2 is a perspective exploded view of a handle for a cooking vessel according to a second exemplary embodiment of the invention;

FIG. 3 shows the handle according to FIG. 2 in the fitted state with the interior of the handle indicated by broken lines;

FIG. 4 is a perspective view of a handle for a cooking vessel according to a third exemplary embodiment of the invention in the fitted state with the interior of said handle indicated by broken lines;

FIG. 5 is a perspective view of a handle for a cooking vessel according to a fourth exemplary embodiment of the invention in the fitted state;

FIG. 6 is a perspective exploded view of a handle for a cooking vessel according to a fifth exemplary embodiment of the invention;

FIG. 7 is a perspective view of a handle for a cooking vessel according to the fifth exemplary embodiment of the invention in the fitted state; and

FIG. 8 is a further perspective exploded view of the handle according to FIG. 6.

### DETAILED DESCRIPTION OF THE EXEMPLARY EMBODIMENTS

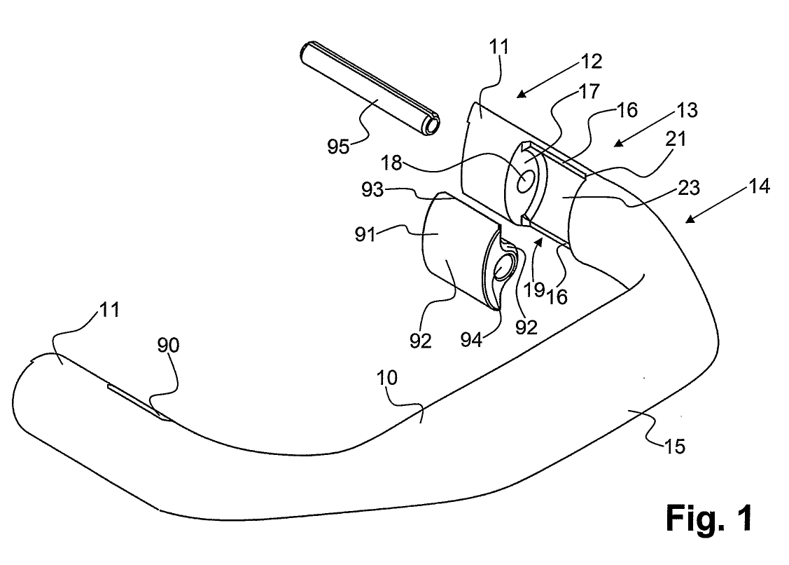

FIG. 1 shows a handle 10 for a cooking vessel (not shown in the drawings) according to a first exemplary embodiment of the invention. The handle 10 is, for example, U-shaped and is fastened at its two free ends 11 to a cooking vessel. It can however also be L-shaped and have just one free end 11 for fastening to a cooking vessel. The fastening to the cooking vessel by, for example, projection welding is preferably carried out after fitting of the handle according to the invention.

Advantageously, this one-piece handle 10 is made of metal and is hollow, it is manufactured from a tube or a sheet metal part, or it is manufactured from solid material by, for example, forging or casting. Both free ends 11 can have a respective fastening region 12 which is adjoined by a transition region 13 according to the invention and finally the actual first portion of the handle region 14. The regions 12 and 13 are in this case arranged respectively parallel to one another in relation to their longitudinal axis on both sides and are perpendicular to the actual handle region 15. The handle region 15 has a length which allows a user conveniently to grasp by hand the region 15, including a pot cloth or similar aid gripped beforehand by the user.

The portion 14 is advantageously oriented in alignment with the portions 12 and 13, although it can also be very short in its configuration, provided that it (see below) is sufficient to receive the protruding length of the locking pin 95. The portion 12 is fastened to the pot, as an example of a cooking vessel, and is conventionally oriented in this case not directly radially to the center of the pot. The deviation from the radial orientation depends on the length of the grip region 15 and the size of the cooking vessel. Crucial for simple utilization of a handle 10 of this type with two free ends or one free end 11 is the tangential orientation of the grip region 15.

In the case of a handle for a pan, it is often desirable to have just a single rod-shaped handle, the grip portion 15 being oriented radially. All portions 12, 13 and 14 are then oriented preferably radially to the grip portion 15.

In the case of a hollow handle 10, the metal sleeve forming said handle can have in cross section a metal thickness in the jacket of between 1/20 and ⅛ of the total diameter of the handle 10. In the transition region 13, a partial region of the jacket material of the handle 10 is omitted and thus forms a lateral opening 19 which is arranged relative to a remaining metal region 23. In the embodiment illustrated in FIG. 1, this is the respectively inwardly directed half of the handle. Upper and lower jacket rims 16 are thus formed in the upper and lower region of the transition region 13. Preferably, the omitted regions have not been removed in the case of a hollow grip of the transition region 13 but rather have been bent over inward to form the closure regions 17 at the opposing ends of the transition region 13. The closure regions 17 cover in each case advantageously the total cross section of the handle 10 relative to the adjoining regions 12 and 14. A bore 18 is provided in the transition regions 17 in each case approximately centrally, i.e. in alignment with the longitudinal axis of the portions 12 and 14.

Inserted into the lateral opening 19 which results from the omitted region and is in this case 50% of the jacket, but can also be between ⅓ and ⅔ of the total metal surface area, is a ceramic piece 90 which advantageously has an outer jacket surface 91 corresponding substantially to the omitted jacket surface of the transition region 13, thus forming between the regions 12, 13 and 14 a smooth surface such as may be seen in the left-hand side of the image of FIG. 1.

The ceramic piece 90 has, on its inwardly directed side, a contour surface 92 which advantageously fills said cavity of the opening 19 in the omitted transition region 13. The upper and lower rims 93 of the ceramic piece 90 thus rest on the rims 16 of the metal sleeve of the transition region 13 so as to close them off in an interlocking manner. The four corner rims of the ceramic piece 90 can be beveled in order to abut corresponding corner rims 21 on the upper or lower jacket rims 16.

The ceramic piece 90 can be fastened in the socket of the opening 19 by bonding or by soldering. A suitable adhesive must, like the material of the piece 90, likewise withstand elevated temperatures, for example temperatures of at least 250 degrees Celsius and advantageously up to 300 degrees Celsius. According to the illustrated exemplary embodiment, the ceramic piece 90, which is otherwise made of a solid material, is however provided with a through-bore 94 which is oriented in alignment with the hole 18 in the closure surface 17, thus allowing a locking pin 95 to be inserted from the free end 11 of the handle 10 through these holes and bores 18 and 94. The locking pin 95 is in this case advantageously an elongate spring washer which, in its compressed state, is inserted through the bores 18 and 94 in order then in the relaxed state to hold the ceramic piece 90 securely in the handle 10.

After this production step, the handle 10 is then fastened to the cooking vessel in a known manner, for example by welding.

Instead of the ceramic piece 90, a plastics material piece can also be used in all exemplary embodiments of the invention, a plastics material which withstands high temperatures, for example temperatures of 250 or even 300 degrees Celsius, being selected.

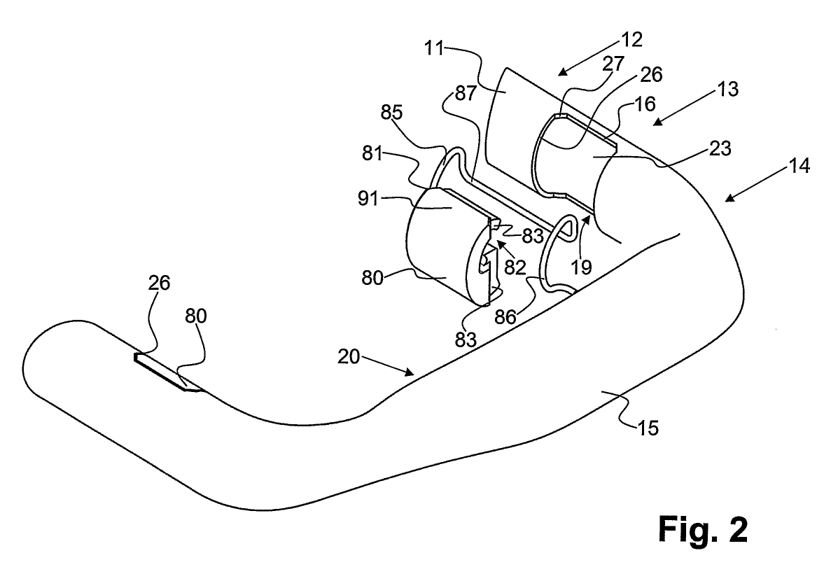

FIG. 2 shows a handle 20 for a cooking vessel according to a second exemplary embodiment of the invention. Identical and similar features are in all figures denoted in the various exemplary embodiments by the same reference numerals. The handle 20 has, in this case too, the three successive regions 12, 13 and 14 at the free ends 11. In contrast to the first exemplary embodiment, the metal material which ultimately forms the opening 19 is in this case however completely punched out or omitted in the transition region 13, thus forming lateral jacket surfaces 26 to the left and right next to the upper and lower jacket rims 16. The regions of transition between the rim surfaces 16 and 26 are also approximated by transition rims 27 so as to avoid an acute angle in the corners. Instead of the rims 27 in the form of a polygonal course consisting of three regions, transition regions 27 which are rounded or elliptical in shape can also be provided.

The ceramic piece 80 to be used in this case has, like the ceramic piece 90 in the first exemplary embodiment, an outer jacket surface 91 which, in interplay with the recess 19, allows complete outward closure of the transition region 13. Accordingly, rim regions 81 are configured at this location to form with the rims 27 the closure in the corners. A groove 82 is provided on the inner side relative to the handle 20 to receive a holding clip 85. The remainder of the back of the ceramic piece 80 is in this case configured so as to be not fully complementary to the remainder of the jacket region of the transition region 13. There is however at the upper and lower end of the ceramic piece 80 a protruding projection 83 which respectively engages below the rims 16 with the cavity of the opening 19.

During fitting, the holding clip 85, which has the function of a clasp, is inserted from the free end 11 into the fastening portion 12 and braced in the regions 12 and 14 by the lateral side arm regions 86 following the inner and outer shape of the portions 12 and 14. The longitudinal clip arm 87, which extends parallel to the main axis of the regions 12, 13 and 14, is in this case arranged in the cavity 19 in such a way that the groove 82 in the ceramic piece 80 can be clipped into this cavity to ensure a connection, which is held with prestressing, between the ceramic piece 80 and handle 20.

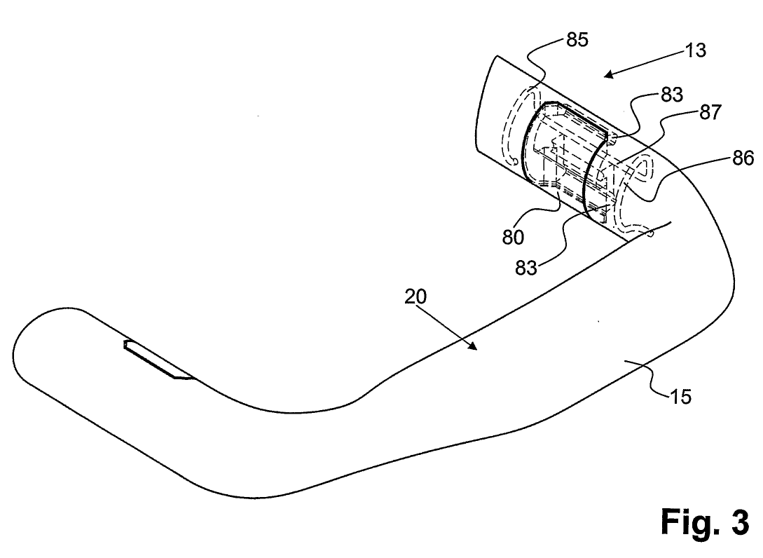

FIG. 3 shows the exemplary embodiment of FIG. 2 now in a fitted state, the inner elements being indicated by broken lines. As may clearly be seen, a respective partial region 83 of the ceramic insert piece 80 is arranged below the jacket in the transition region 13 and thus forms a further sealing closure. In this case, the jacket surface 91 of the ceramic piece 80 is configured in such a way that parts of the upper and lower jacket rims 16 and parts of the lateral jacket surfaces 26 protrude, i.e. the jacket surface 91 is not configured flush with the surface of the portions 12, 13 and 14, but is rather slightly set back.

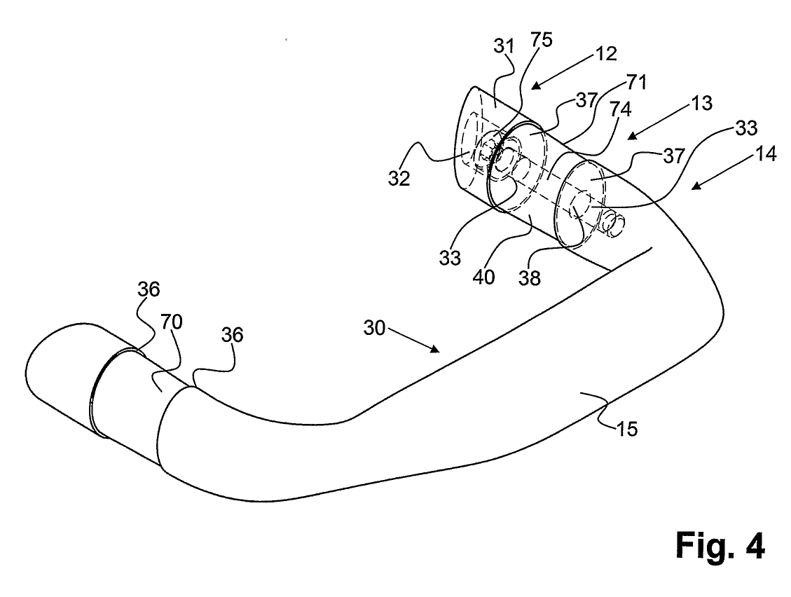

FIG. 4 shows a third exemplary embodiment of a handle 30 according to the teaching of the invention. In this case, the transition region 13 is formed as a result of the fact that an end piece 31 of the third handle 30 has been separated from the remaining handle and is thus, in particular, cut off from the region 14. A hollow tube may in this case have been split accordingly. It may however also, as in the exemplary embodiment illustrated in FIG. 4, have been manufactured separately and in particular from solid material. In this respect, the transition region 13 in the handle 30 according to FIG. 4 consists exclusively of a ceramic piece 70. This ceramic piece 70 is in this case configured in a somewhat smaller diameter than the adjacent portions 12 and 14, so a small edge 36 protrudes peripherally on both sides relative to the portions 12 and 14.

The ceramic piece 70 can however also be configured flush with the handle. The two regions 12 and 14 are advantageously configured with a closure lid 37 which closes them and in each case advantageously has a bore 38 in its central orientation and longitudinal orientation. The ceramic piece 70 itself likewise has a central bore 74.

In the exemplary embodiment illustrated in FIG. 4, the end region 31 is made not of a thin metal sheet but rather of solid material in which a cylindrical bore 32 is formed. Through this bore, which has a narrowing step, corresponding to the diameter of the bore 33, in the ceramic part 70 can be inserted from the free end region 11 a screw 75 (in this case with a hexagon socket) which screws the part 31, the ceramic part 70 and the remainder of the handle 30 in the bore 33 if a corresponding thread is provided at this location in the portion 14.

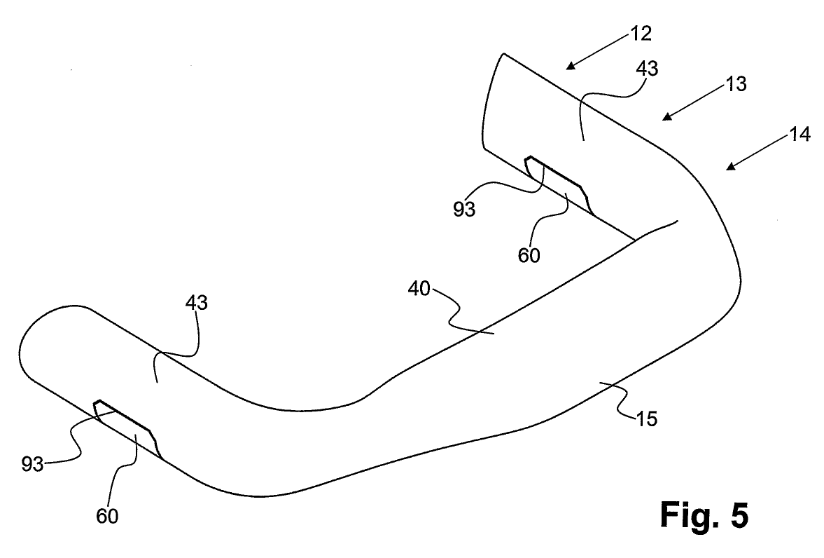

Finally, FIG. 5 shows a handle 40 for a cooking vessel in a fitted state according to a fourth exemplary embodiment of the invention. The construction of the ceramic piece 60 corresponds to that of the first exemplary embodiment. As may clearly be seen, the respective rims 93 of the ceramic insert piece 60 are in this case arranged symmetrically relative to the underside of the handle 40, so the insert piece 60 is oriented downward. The remaining jacket 43 of the handle 15 in the transition region 13 is arranged oriented upward and thus forms a conductive region which is exposed still less to the heat. In this case, the jacket surface of the ceramic piece 60 is configured in such a way that the ceramic piece covers all of the lower surface of the handle 40; in cross section (not shown), this corresponds to 180 degrees. For the remainder of the jacket, this angular coverage leads to a substantially identical angle of coverage of 180 degrees. The ceramic or plastics material piece can also take up a smaller angle which can be, for example, up to at least 120 degrees (advantageously plus/minus 60 degrees with respect to the horizontal plane in the exemplary embodiments according to FIG. 1 to 3 and with respect to the vertical plane in the exemplary embodiment according to FIG. 5). Larger angles of up to 270 degrees are also possible.

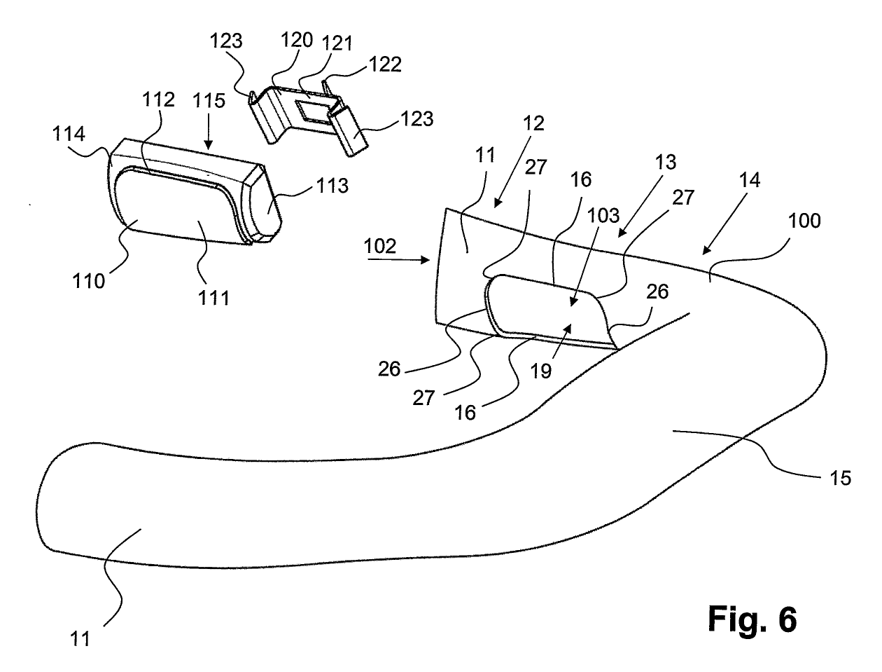

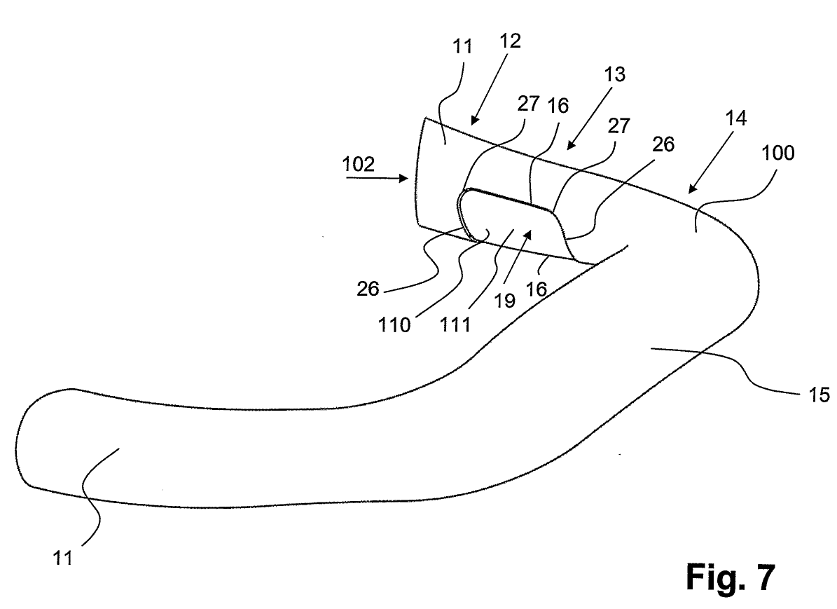

FIGS. 6 to 8 are perspective views of a fifth exemplary embodiment according to the present invention. Like parts are provided with the same reference numerals. The fifth exemplary embodiment comprises substantially a handle 100, a ceramic piece 110 and a spring piece 120.

The handle 100 has an opening 19 which is delimited by jacket edges 16 and lateral jacket edges 26. The opening 19 is substantially rectangular in its configuration. The region in which the jacket edges 16 meet the lateral jacket edges 26 is preferably rounded in its configuration with a transition region 27. The handle 100 is hollow in its configuration and has an inner wall 103. In its free end region, the handle 100 additionally has an insertion opening 102. The ceramic piece 110 and the spring piece 120 can be inserted into the hollow handle 100 through the insertion opening 102.

The ceramic piece 110 comprises substantially a ceramic body 113 with a jacket surface 111 having jacket rims 112 and a back 115. The jacket surface 111 corresponds substantially to the omitted jacket surface of the transition region 13, thus forming a smooth surface between the regions 12, 13 and 14 on insertion of the ceramic piece 110 in the opening 19. The jacket surface 111 is delimited by the jacket rims 112. The form of the jacket rims 112 is in this case configured so as to correspond substantially to the contour of the opening 19 which is defined by the jacket edges 16, the lateral jacket edges 26 and the transition regions 27. Accordingly, the ceramic piece 110 can be fitted into the opening 19 in an interlocking manner. As soon as the ceramic piece 110 has been fitted, it rests with the stop surface 114 of the ceramic body 113 against the inner wall 103 of the handle 100. Preferably, the distance between the stop surface 114 and jacket surface 111 corresponds to the thickness of the wall of the handle. Thus, the ceramic piece 110 can be arranged or fitted in such a way that the jacket surface 111 is flush with the outer surface of the handle 100.

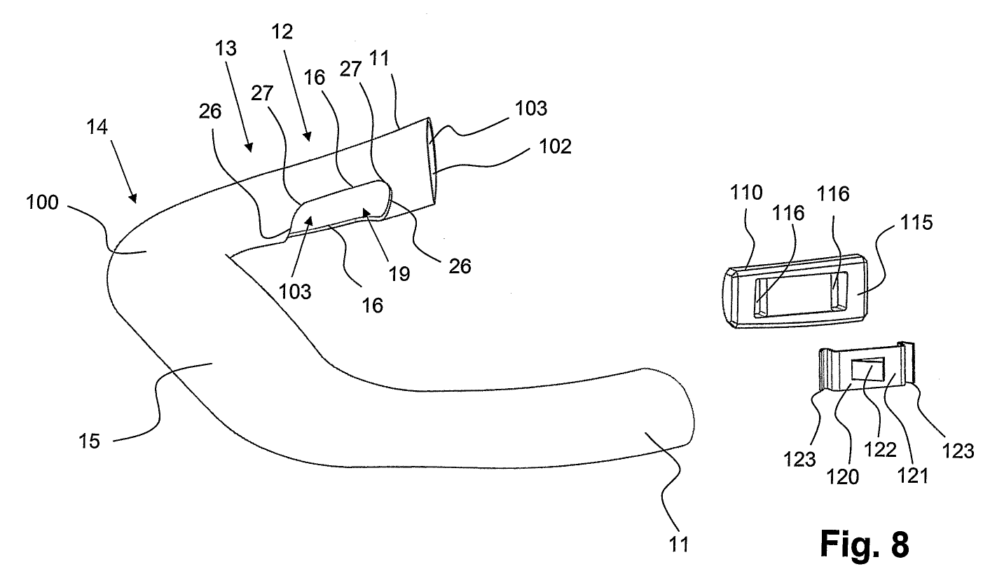

FIG. 8 shows the ceramic piece 110 from behind. The ceramic piece 110 has on the back 115 receiving openings 116. The back 115 is arranged relative to the jacket side 111 on the ceramic body 113. The receiving openings 116 can receive parts of the spring body 120. The receiving openings 116 have substantially a rectangular cross section.

The spring piece 120 has in a central region a basic element 121 with a spring tab 122 and a respective spring leg in the two end regions 123 adjoining the central region. The spring tab 122 and the spring legs 123 protrude from the basic element 121 in differing directions. The spring tab 122 is in this case in the form of a web protruding from the basic element 121. The spring legs 123 are configured as bent-over legs protruding from the basic element. The spring legs 123 engage with the receiving openings 116 in the ceramic piece 110. The shape of the bend at their ends enables the spring legs 123 to produce, after compression of the bend, a spring leg force which is substantially perpendicular to the spring legs 123.

By means of the spring piece 120, which is arranged between the inner wall 103 and the ceramic body 113, the spring tabs 122 produce a spring force which presses the spring piece 120 with the surface 114 against the inner wall 103 of the handle. In this case, the spring legs 123 are in engagement with the ceramic body 110 and the spring tab 122 rests on a region of the inner wall 103 that opposes the opening 19.

The spring piece 120 is connected in a first step to the ceramic piece 110. In other words, the spring legs 122 engage with the described receiving openings 116. The spring leg force ensures that the spring piece 120 cannot become detached from the ceramic piece 110. Subsequently, the ceramic piece 110 is inserted with the spring piece 120 into the hollow handle 100 through the insertion opening 102. As soon as the spring tab 122 has been inserted into the cavity and accordingly touches the inside 103, this spring tab 122 exerts a spring force onto the ceramic piece 110 and presses the ceramic piece with the jacket surface 111 against the inside 103. The ceramic piece 110 and the spring piece 120 are then pushed further until the jacket rims 112 are congruent with the jacket edges 16, the lateral jacket edges 26 and the transition regions 27. Then, the ceramic piece 110 is pressed by the spring piece 120 in the direction of the opening 19 and then engages in an interlocking manner. As a result of the spring force which presses the ceramic piece in the direction of the inner wall 103 and as a result of the interlocking delimitation provided by the jacket edges 16, the lateral jacket edges 26 and by the transition regions 27, the ceramic piece is blocked in the opening 19 in a force-transmitting or an interlocking manner.

All exemplary embodiments have in common the fact that there is a fastening portion 12 at and by which the handle 10, 20, 30 or 100 is fastened to a cooking vessel. This fastening portion 12 can, in particular, have a length of from 5 to 25 millimeters. As a result, the thinned or missing metal portion 13 commences advantageously at a distance of from 5 to 25 millimeters, especially preferably between 10 and 15 millimeters, after a portion 12 close to the cooking vessel, and heat conduction can be prevented effectively in the direction of the grip region 15. On the one hand the thinned or missing metal region in the portion 13 tends to reduce the conduction of heat from the cooking vessel itself, on the other hand the hot air, which is found in particular in gas stoves and rises at the edge of the pot, or other gases can no longer heat the handle 10, 20, 30 or 100. Firstly improved heat insulation is achieved as a result of the closure of the hollowed-out or omitted intermediate region 13 by means of a ceramic element 70, 80, 90 or 110, secondly the interlocking fit resulting from this ceramic element 70, 80, 90 or 110 improves the stability of the handle and finally this configuration allows the handle 10, 20, 30 or 100 to be configured in a hollow design, in particular by shaping a thin metal sheet, preferably in tubular form, to form a grip region 15 without the gases rising in proximity to the edge of the pot being able to infiltrate and directly heat up this hollow region. The transition portion 13 itself advantageously has a length of from 10 to 30 millimeters, particularly preferably between 15 and 25 millimeters. The jacket surface 91 or 71 in this case interlocks with the adjacent regions 12 and 14, preferably substantially similarly with only low rim steps. The remaining metal regions 23 of the portion 13 can, as is illustrated, be configured perpendicularly and thus be oriented in the main direction of hot gases flowing past, although they can also be arranged substantially horizontally, in which case the ceramic pieces 60 are directed downward counter to the gases flowing past. In other embodiments not illustrated in the figures, the heat-insulating pieces 60, 70, 80, 90, 110 are arranged on the respectively outwardly directed half of the handle, wherein the term “half” is to be understood in the sense of primarily on this side, as the angular coverage can, as mentioned above, also be greater and less than 180 degrees.

The drawings show in each case pot grips 10, 20, 30, 40, 100 with two free ends. It will be clear to a person skilled in the art that there can also be configured in this way, for example, pan grips which have just one free end 11, so there is also only one respective portion 12, 13 and 14.

The metallic material used for the portions 12, 13, if present, 14 and 15 is in particular stainless steel, although further metals used for handles in the kitchen area are also possible.

The ceramic material used can be all materials having high thermal stability, such as 250 degrees Celsius, preferably greater than 300° C., and low thermal conductivity, preferably less than 5 Wk⁻¹m⁻¹, such as for example zirconium oxide, magnesium aluminum silicate or else glass ceramic.

The portions 12 and 14 are substantially metallic. Nevertheless, it will be clear to a person skilled in the art that elements in the portions 12 and 14, in particular in the grip region 15, made of other heat-resistant materials, for example of plastics material, do not lead a pot grip of this type out of the scope of the present invention either. Other substances may also be used for these thermal barriers, provided that they withstand temperatures of preferably greater than 300° C. and have low thermal conductivity, preferably in the range of less than 5 Wk⁻¹m⁻¹.

### LIST OF REFERENCE NUMERALS

10 Handle according to a first exemplary embodiment
11 Free end region
12 Fastening portion
13 Transition portion
14 First portion of the handle region
15 Grip portion
16 Upper/lower jacket rim
17 Closure region
18 Hole
19 Opening
20 Handle according to a second exemplary embodiment
21 Corner rim
23 Remaining metal region
26 Lateral jacket surface
27 Transition region
30 Handle according to a third exemplary embodiment
31 End piece
32 Bore
33 Continuous bore
36 Peripheral edge
37 Closure lid
38 Bore
40 Handle according to a fourth exemplary embodiment
43 Remaining metal region
60 Ceramic piece
70 Ceramic piece
71 Jacket surface
74 Bore
75 Screw
80 Ceramic piece
81 Corner region
82 Groove
83 Protruding projection
85 Holding clip
86 Side arm region
87 Longitudinal clip arm
90 Ceramic piece
91 Jacket surface
92 Inner contour surface
93 Rim
94 Through-bore
95 Locking pin
100 Handle according to a fifth exemplary embodiment
102 Insertion opening
103 Inner wall
110 Ceramic piece
111 Jacket surface
112 Jacket rims
113 Ceramic body
114 Stop surface
115 Back
116 Receiving openings
120 Spring piece
121 Basic element
122 Spring tab
123 Spring leg

1-10. (canceled)

11. A cooking vessel having a handle, wherein the handle comprises:
a substantially metallic grip portion;
a transition portion being adjacent to said grip portion;
at least one substantially metallic fastening portion being adjacent to said transition portion for fastening said handle to the cooking vessel;
wherein the transition portion comprises:
a metal portion being integrally connected to the adjacent grip portion and the adjacent fastening portion and having a cross section which is reduced compared to the adjacent grip portion and the adjacent fastening portion; and
a thermal barrier being connected to the adjacent metal portion by one of a form closure or a force closure.

12. The cooking vessel according to claim 11, wherein a spring element is provided to brace the thermal barrier against the handle.

13. The cooking vessel as claimed in claim 11, wherein the thermal barrier has a longitudinally extending groove and wherein a clip is provided to be inserted in the metal portion and to brace the thermal barrier against the handle.

14. The cooking vessel as claimed in claim 11, wherein the thermal barrier has projections which protrude below the edge of the transition portion.

15. The cooking vessel as claimed in claim 12, wherein the thermal barrier comprises stop surfaces which extend under edges of the transition portion, and wherein the spring element is designed such to be introduced into the transition portion and to brace the thermal barrier against the transition portion of the handle.

16. The cooking vessel as claimed in claim 11, wherein the thermal barrier includes a jacket surface positioned substantially flush with the adjoining metal portions.

17. The cooking vessel as claimed in claim 11, wherein the fastening portion has a length of from 5 to 25 millimeters.

18. The cooking vessel as claimed in claim 17, wherein the fastening portion has a length of from 10 to 15 millimeters.

19. The cooking vessel as claimed in claim 11, wherein the transition portion has a length of from 10 to 30 millimeters

20. The cooking vessel as claimed in claim 19, wherein the transition portion has a length of from 15 to 25 millimeters.

21. The cooking vessel as claimed in claim 11, wherein the thermal barrier is made of a material which withstands temperatures of greater than 250° C. and has thermal conductivity of less than 5 Wk⁻¹m⁻¹.

22. The cooking vessel as claimed in claim 11, wherein the thermal barrier is made of a ceramic material.

23. The cooking vessel as claimed in claim 22, wherein the thermal barrier is made of a ceramic material selected from the group consisting of zirconium oxide, magnesium aluminum silicate, and glass ceramic.

24. The cooking vessel as claimed in claim 11, wherein the thermal barrier is made of a plastics material.

25. The cooking vessel as claimed in claim 11, wherein the thermal barrier has a jacket surface which is arranged symmetrically relative to a plane which is parallel to the base of the cooking vessel or symmetrically relative to a plane which is arranged perpendicularly thereto and comprises the longitudinal axis of the handle and wherein the thermal barrier covers an angle of between 120 and 270 degrees.

26. The cooking vessel as claimed in claim 25, wherein the thermal barrier covers an angle of approximately 180 degrees.
